(19) United States
(12) Patent Application Publication
(10) Pub. No.: US 2020/0073733 A1
(43) Pub. Date: Mar. 5, 2020

(54) Method and Apparatus for Executing Task by Intelligent Device

(71) Applicant: Huawei Technologies Co., Ltd., Shenzhen (CN)

(72) Inventor: Nanjun Li, Shenzhen (CN)

(21) Appl. No.: 16/679,558

(22) Filed: Nov. 11, 2019

Related U.S. Application Data
(63) Continuation of application No. PCT/CN2018/087616, filed on May 21, 2018.

(30) Foreign Application Priority Data
Jun. 28, 2017 (CN) 201710508911.9

(51) Int. Cl. G06F 9/54; G06F 9/38; G06F 9/48; G06F 17/18; G06N 20/00

(52) U.S. Cl. CPC G06F 9/542; G06F 9/3855; G06N 20/00; G06F 17/18; G06F 9/4806

(57) ABSTRACT

A method executing a task by an intelligent device is disclosed, including, when at least one piece of triggering information is detected, determining, based on the at least one piece of triggering information, at least one to-be-processed event triggered by the at least one piece of triggering information, where the at least one event is different from each other, the triggering information is outside information detected by the intelligent device using a sensor, selecting, for each determined event and from at least one task corresponding to the event, a target task corresponding to the event, where the task is a processing manner available to the intelligent device for the event that happens outside, and executing the target task corresponding to each event.

### CROSS-REFERENCE TO RELATED APPLICATIONS

This application is a continuation of International Patent Application No. PCT/CN2018/087616, filed on May 21, 2018, which claims priority to Chinese Patent Application No. 201710508911.9, filed on Jun. 28, 2017. The disclosures of the aforementioned applications are hereby incorporated by reference in their entireties.

### TECHNICAL FIELD

This application relates to the field of artificial intelligence technologies, and in particular, to a method and an apparatus for executing a task by an intelligent device.

### BACKGROUND

With development of artificial intelligence technologies, various intelligent devices are widely applied. For example, an intelligent device may be a robot that may call, once finding a person falling on the ground, the person's family member.

Currently, a robot may execute various types of tasks, for example, execute an image processing task, a speech recognition task, and a task of dialing a phone number. Specific processing of executing a task by the robot may be the robot may pre-store a correspondence between triggering information and a task, the robot may detect different triggering information using various components (for example, a photographing component and a voice obtaining component), and each time when the robot detects triggering information using a component, the robot may determine, based on the pre-stored correspondence between triggering information and a task, a task corresponding to the triggering information, and then may execute the task. For example, when the robot detects, using the photographing component, triggering information “A person falls on the ground”, the robot may execute the task of dialing a phone number.

The other approaches have at least the following problem.

In many cases, triggering information detected using different components may correspond to a same task. For example, when a person falls on the ground, the robot may detect triggering information “A person falls on the ground” using the photographing component, or may detect triggering information “A person falls on the ground” using the voice obtaining component. In this case, the triggering information detected by the two components corresponds to a same event (a person falls on the ground), that is, correspond to a same task. Based on the manner in which the robot executes a task, in this case, the robot may execute the corresponding task twice for the same event corresponding to the two pieces of triggering information, leading to resource waste.

### SUMMARY

To resolve a problem of resource waste, embodiments of this application provide a method and an apparatus for executing a task by an intelligent device. The technical solutions are as follows.

According to a first aspect, a method for executing a task by an intelligent device is provided. The method includes determining, based on at least one piece of triggering information when an intelligent device detects the at least one piece of triggering information, at least one to-be-processed event triggered by the at least one piece of triggering information, where the at least one event is different from each other, the triggering information is outside information detected by the intelligent device using a sensor, and the event is an event that happens outside and that is determinable for the intelligent device when the intelligent device detects the triggering information, selecting, for each determined event and from at least one task corresponding to the event, a target task corresponding to the event, where the task is a processing manner available to the intelligent device for the event that happens outside, and executing the target task corresponding to each event.

In the solution in this embodiment of this application, each time when the intelligent device detects the at least one piece of triggering information, the intelligent device may combine all detected triggering information to determine the at least one to-be-processed event that is different from each other and that is triggered by all the triggering information. Triggering information detected by a robot is not in one-to-one correspondence with an event, and different triggering information may trigger a same event. The detected at least one piece of triggering information may be detected at the same time, or may be detected within relatively short preset duration. After the triggered event is determined, the target task corresponding to each event may be determined such that the intelligent device can execute the target task corresponding to each event. In this way, the robot combines the detected triggering information to determine events that are different from each other in order to prevent a corresponding task from being executed twice for a same event corresponding to different triggering information, thereby preventing resource waste.

In a possible implementation, the determining, based on at least one piece of triggering information when an intelligent device detects the at least one piece of triggering information, at least one to-be-processed event triggered by the at least one piece of triggering information includes determining, when the intelligent device detects the at least one piece of triggering information, a to-be-processed event triggered by each piece of detected triggering information, and performing deduplication processing on all determined events, to obtain the at least one to-be-processed event triggered by the at least one piece of triggering information.

In the solution in this embodiment of this application, when the intelligent device detects the at least one piece of triggering information, for each piece of triggering information, the intelligent device may determine the event triggered by the triggering information, and then may delete a repeated event of the events triggered by the triggering information, and determine, as the at least one to-be-processed event triggered by the at least one piece of triggering information, remaining events that are different from each other of the events triggered by the triggering information.

In a possible implementation, the determining, when the intelligent device detects the at least one piece of triggering information, an event triggered by each piece of detected triggering information includes, when the intelligent device detects the at least one piece of triggering information, classifying each piece of detected triggering information based on a pre-trained classification model and each event in an event set, and determining the event corresponding to each piece of triggering information.

In the solution in this embodiment of this application, each time when the intelligent device detects the at least one piece of triggering information, the intelligent device may use each of the at least one piece of triggering information as an input of a neural network algorithm (a classifier), classify each piece of triggering information using the neural network algorithm (that is, using a training network), and determine a category corresponding to the triggering information (that is, determine the event triggered by the triggering information). Each category in the neural network algorithm may be each event in a set of events that can be recognized by the robot, as shown in FIG. 3A. After the category of each piece of triggering information is determined, a repeated event may be deleted, to obtain the event triggered by the at least one piece of triggering information.

In a possible implementation, the selecting, for each determined event and from at least one task corresponding to the event, a target task corresponding to the event includes, for each determined event, selecting, from the at least one task corresponding to the event and based on a selection probability of each of the at least one task corresponding to the event, the target task corresponding to the event.

In the solution in this embodiment of this application, after determining the at least one triggered event, for each of the at least one event, the intelligent device may determine, based on a correspondence between an event, a task, and a selection probability, the at least one task corresponding to the event, and then may randomly select, from a plurality of tasks and based on the selection probability corresponding to each determined task, the target task corresponding to the event. The selection probability represents a possibility that a corresponding task is selected.

In a possible implementation, the method further includes, when a satisfaction degree value entered for execution of a first task of a target task corresponding to a first event is received, adjusting, based on the entered satisfaction degree value, a selection probability of the first task corresponding to the first event.

In the solution in this embodiment of this application, a human-computer interaction interface (a visible graphical interface and a touch manner) may be disposed on the intelligent device, and a user may make manual intervention using the human-computer interaction interface. Further, each time after the intelligent device executes the target task corresponding to the triggered event (which may be referred to as the first event), that is, after the intelligent device executes a target task corresponding to an event or when the intelligent device executes a target task corresponding to an event, the user may enter, based on a satisfaction degree of the user, a satisfaction degree value for current execution of the first task of the target task corresponding to the event, and the intelligent device may receive the satisfaction degree value (which may be represented by s, and s may be a value greater than 0 and less than 1) that is entered by the user for execution of the first task corresponding to the first event by the intelligent device. In this case, the intelligent device may adjust the selection probability of the first task corresponding to the first event. In addition, the intelligent device may further adjust a selection probability of an event other than the first event of all events corresponding to the first task. In this way, when the user expects the device to process an event in a processing manner, the user may enter a relatively high satisfaction degree value for a target task executed by the intelligent device such that the intelligent device can increase a selection probability of the target task corresponding to the event, and the intelligent device keeps adapting to a habit of the user.

In a possible implementation, the method further includes determining, based on pre-stored importance and urgency that correspond to each event in the event set, importance and urgency that correspond to each of the at least one event, and determining, for each event, a priority of the event based on the determined importance and urgency that correspond to the event, where the executing the target task corresponding to each event includes executing, based on the priority of each event in descending order of priorities, the target task corresponding to each event.

In the solution in this embodiment of this application, the intelligent device may pre-store the importance and urgency that correspond to each event in the event set. After determining the at least one triggered event, the intelligent device may determine, from the pre-stored importance and urgency that correspond to events in the event set, the importance and urgency that correspond to each of the at least one event, and then may determine, for each event, the priority of the event based on the determined importance and urgency that correspond to the event. For example, a sum of the importance and urgency that correspond to the event may be calculated, and the calculated sum may be used as the priority of the event. After determining the priority of each event, the intelligent device may execute, in descending order of priorities, the target task corresponding to each event. In this way, when a plurality of events need to be processed, the intelligent device may preferentially process a more important and urgent event.

In a possible implementation, the determining, for each event, a priority of the event based on the determined importance and urgency that correspond to the event includes, for each event, obtaining an actual cost and an expected cost of previous execution of a task corresponding to the event, determining, based on the actual cost and the expected cost of the previous execution of the task corresponding to the event, an expected cost required for current execution of the target task corresponding to the event, and determining the priority of the event based on the determined importance and urgency that correspond to the event and the determined expected cost required for the current execution of the target task corresponding to the event.

In the solution in this embodiment of this application, each time after the intelligent device executes a task corresponding to each event in the event set, that is, each time after the intelligent device processes the event, the intelligent device may record an actual cost of current execution of the task corresponding to the event. The actual cost may be energy (for example, electric power or central processing unit usage) or time consumed for executing the task corresponding to the event, or may be a combination of energy and time. After determining at least one currently-triggered event, the intelligent device may obtain, for each event, the actual cost and the expected cost of the previous execution of the task corresponding to the event, and then may determine the expected cost required for the current execution of the target task corresponding to the event. After obtaining the expected cost and corresponding importance and urgency, the robot may determine the priority of the event.

In a possible implementation, the determining, based on pre-stored importance and urgency that correspond to each event in the event set, importance and urgency that correspond to each of the at least one event includes determining, based on a pre-stored importance-urgency matrix and an event corresponding to each position in the importance-urgency matrix, the importance and urgency that correspond to each of the at least one event, where each position in the importance-urgency matrix represents importance and urgency of the event corresponding to the position.

In the solution in this embodiment of this application, the intelligent device may pre-store the importance-urgency matrix. Positions in the importance-urgency matrix correspond to different events, each position represents the importance and urgency of the event corresponding to the position, and the matrix may be referred to as an Eisenhower Decision Matrix (EDM). After determining the at least one event, the intelligent device may determine, from the importance-urgency matrix, importance and urgency that correspond to a position of each of the at least one event in the importance-urgency matrix.

In a possible implementation, the method further includes, for each event in the event set, determining, based on pre-stored corresponding probabilities of the event in positions in the importance-urgency matrix, a position corresponding to a largest probability as a position corresponding to the event.

In the solution in this embodiment of this application, the intelligent device may preset the corresponding probabilities of each event in the positions in the importance-urgency matrix. The probability may be a value having a preset quantity of digits, and a sum of the corresponding probabilities of each event in the positions in the importance-urgency matrix is one. For each event in the event set, when determining the position of each event in the importance-urgency matrix, the intelligent device may determine the largest probability from the corresponding probabilities of the event in the positions in the importance-urgency matrix, and then may determine the position corresponding to the largest probability as the corresponding position of the event in the importance-urgency matrix.

In a possible implementation, the method further includes, when an instruction for adjusting a position corresponding to a second event from a first position to a second position is received, obtaining an excitation factor corresponding to each position in the importance-urgency matrix for the adjustment instruction, where an excitation factor corresponding to the second position is largest, and an excitation factor corresponding to the first position is smallest, calculating, based on the obtained excitation factor corresponding to each position in the importance-urgency matrix and corresponding probabilities of the second event in the positions in the importance-urgency matrix, new corresponding probabilities of the second event in the positions in the importance-urgency matrix, and determining, based on the new corresponding probabilities of the second event in the positions in the importance-urgency matrix, the second position corresponding to a new largest probability as the position corresponding to the event.

In the solution in this embodiment of this application, the intelligent device may pre-store the excitation factor ^{K}corresponding to each position in the importance-urgency matrix. For different adjustment instructions, excitation factors corresponding to each position in the importance-urgency matrix are different. For an event whose position is adjusted, an excitation factor corresponding to a position after adjustment is largest, an excitation factor corresponding to a position before adjustment is smallest, and an excitation factor corresponding to another position is between the largest and the smallest. When the user adjusts the position corresponding to the second event from the first position to the second position, the intelligent device may receive the instruction for adjusting the position corresponding to the second event from the first position to the second position. In this case, the intelligent device may obtain the excitation factor corresponding to each position in the importance-urgency matrix for the adjustment instruction, and then may adjust, using the excitation factor corresponding to each position, a corresponding probability of the second event in each position in the importance-urgency matrix, to obtain the new corresponding probabilities of the second event in the positions in the importance-urgency matrix (that is, obtain the corresponding probabilities of the second event in the positions in the importance-urgency matrix after position adjustment). After obtaining the new corresponding probabilities of the second event in the positions in the importance-urgency matrix, the intelligent device may determine, based on the new corresponding probabilities of the second event in the positions in the importance-urgency matrix, the second position corresponding to the new largest probability as the position corresponding to the event.

In a possible implementation, the method further includes, when an instruction for adjusting a position corresponding to a second event from a first position to a second position is received, determining a corresponding probability of the second event in the first position in the importance-urgency matrix as a new corresponding probability of the second event in the second position, and determining a corresponding probability of the second event in the second position in the importance-urgency matrix as a new corresponding probability of the second event in the first position, and determining, based on new corresponding probabilities of the second event in the positions in the importance-urgency matrix, the second position corresponding to a new largest probability as the position corresponding to the event.

In the solution in this embodiment of this application, when receiving the instruction for adjusting the position corresponding to the second event from the first position to the second position, the intelligent device may adjust only the corresponding probabilities of the second event in the first position and the second position, and does not adjust probabilities corresponding to the other positions. Further, when the instruction for adjusting the position corresponding to the second event from the first position to the second position is received, the corresponding probability of the second event in the first position in the importance-urgency matrix may be determined as the new corresponding probability of the second event in the second position, and the corresponding probability of the second event in the second position in the importance-urgency matrix may be determined as the new corresponding probability of the second event in the first position. In other words, the intelligent device may interchange the probability of the second event in the first position and the probability of the second event in the second position before adjustment, and determine the interchanged probabilities as the new corresponding probability of the second event in the first position after adjustment and the new corresponding probability of the second event in the second position after adjustment. New probabilities of the second event in the other positions after adjustment are the same as the probabilities of the second event in the other positions before adjustment. After the new corresponding probabilities of the second event in the positions in the importance-urgency matrix are obtained, the second position corresponding to the new largest probability may be determined as the position corresponding to the event.

In a possible implementation, the method further includes, when the second event is a to-be-processed event, re-determining, based on importance and urgency that correspond to the second position in the importance-urgency matrix, a priority corresponding to the second event.

In the solution in this embodiment of this application, as described above, after the at least one triggered event and the target task corresponding to each event are determined, the target task corresponding to each of the at least one event may be added to a current task queue, and after the target task is executed, the target task may be deleted from the current task queue. Based on this case, when a target task corresponding to the second event is in the current task queue, the second event may be determined as a to-be-processed event. In other words, the to-be-processed event may include an event being processed. In addition, the to-be-processed event may alternatively not include an event being processed.

When the second event is a to-be-processed event, the intelligent device may re-calculate, based on the foregoing method for determining a priority of an event, the priority corresponding to the second event. Further, the intelligent device may execute, based on the re-calculated priority, the target task corresponding to the second event. For a case in which the to-be-processed event includes an event being processed, when the re-calculated priority is decreased, execution of the target task corresponding to the event may be suspended, and a target task corresponding to an event having a higher priority is executed.

According to a second aspect, an apparatus for executing a task by an intelligent device is provided. The apparatus includes at least one module, and the at least one module is configured to implement the method for executing a task by an intelligent device in the first aspect.

According to a third aspect, an intelligent device is provided. The intelligent device includes a processor, a memory, and a sensor. The processor is configured to execute an instruction stored in the memory, and the processor implements, by executing the instruction, the method for executing a task by an intelligent device in the first aspect.

According to a fourth aspect, a computer readable storage medium is provided. The computer readable storage medium stores at least one instruction, at least one segment of program, a code set, or an instruction set. The at least one instruction, the at least one segment of program, the code set, or the instruction set is loaded and executed by a processor, to implement the method for executing a task by an intelligent device in the first aspect or any possible implementation of the first aspect.

Technical effects obtained in the second to the fourth aspects of the embodiments of this application are similar to the technical effects obtained using the technical means corresponding to the first aspect, and details are not described herein again.

Beneficial effects of the technical solutions provided in the embodiments of this application are as follows.

In the embodiments of this application, when the at least one piece of triggering information is detected, the at least one to-be-processed event corresponding to the at least one piece of triggering information is determined based on the at least one piece of triggering information, where the determined at least one event is different from each other. For each of the determined at least one event, the target task corresponding to the event is selected from the at least one task corresponding to the event. The target task corresponding to each event is executed. In this way, the robot combines the detected triggering information to determine events that are different from each other in order to prevent a corresponding task from being executed twice for a same event corresponding to different triggering information, thereby preventing resource waste.

### BRIEF DESCRIPTION OF DRAWINGS

FIG. 1 is a schematic diagram of a system framework according to an embodiment of this application.

FIG. 2 is a flowchart of a method for executing a task according to an embodiment of this application.

FIG. 3A is a schematic diagram of determining an event according to an embodiment of this application.

FIG. 3B is a schematic diagram of determining a target task according to an embodiment of this application.

FIG. 4A is a schematic diagram of an event and a target task according to an embodiment of this application.

FIG. 4B is a schematic diagram of an importance-urgency matrix according to an embodiment of this application.

FIG. 5A is a schematic diagram of an event and a target task according to an embodiment of this application.

FIG. 5B is a schematic diagram of a current task queue according to an embodiment of this application.

FIG. 5C is a schematic diagram of a current task queue according to an embodiment of this application.

FIG. 5D is a schematic diagram of a current task queue according to an embodiment of this application.

FIG. 5E is a schematic diagram of a current task queue according to an embodiment of this application.

FIG. 6 is a schematic structural diagram of an apparatus for executing a task according to an embodiment of this application.

FIG. 7 is a schematic structural diagram of an apparatus for executing a task according to an embodiment of this application.

### DESCRIPTION OF EMBODIMENTS

To make the objectives, technical solutions, and advantages of this application clearer, the following further describes in detail the implementations of this application with reference to the accompanying drawings.

Embodiments of this application provide a method for executing a task by an intelligent device. The method is performed by an intelligent device that can execute various types of tasks. The intelligent device may be a robot that can execute various types of tasks. The solutions are described in detail subsequently using an example in which the intelligent device is a robot. Other cases are similar thereto, and are not described.

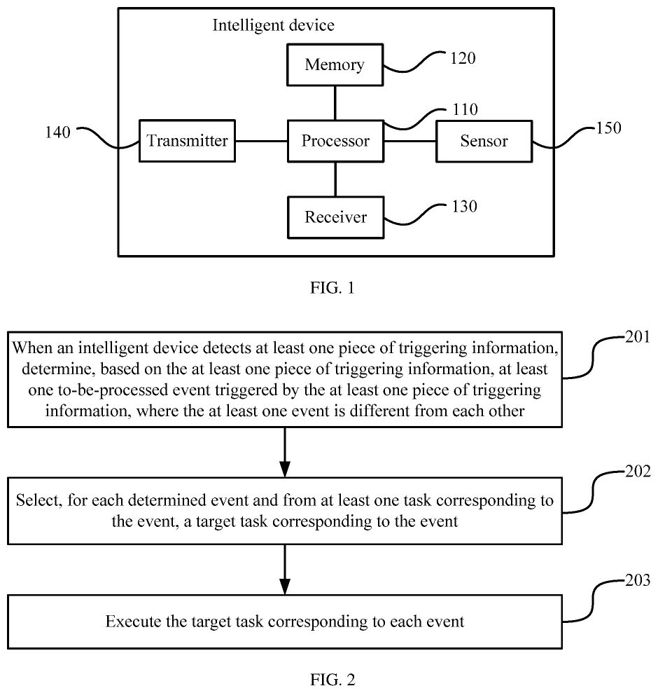

The intelligent device may include a processor 110 and a memory 120, and the processor 110 may be connected to the memory 120, as shown in FIG. 1. The processor 110 may include one or more processing units. The processor 110 may be a general purpose processor, including a central processing unit (CPU), a network processor (NP), or the like, or may be a digital signal processor (DSP), an application-specific integrated circuit (ASIC), a field-programmable gate array (FPGA), another programmable logic device, or the like. Further, a program may include program code, and the program code includes a computer operation instruction. The intelligent device may further include the memory 120. The memory 120 may be configured to store a software program and a module, and the processor 110 reads the software program and the module that are stored in the memory 120, to execute a task. In addition, the intelligent device may further include a receiver 130 and a transmitter 140. The receiver 130 and the transmitter 140 may be separately connected to the processor 110, and the transmitter 140 and the receiver 130 may be collectively referred to as a transceiver. The transmitter 140 may be configured to send a message or data. The transmitter 140 may include but is not limited to at least one amplifier, a tuner, one or more oscillators, a coupler, a low noise amplifier (LNA) , a duplexer, and the like. In addition, the intelligent device may further include a sensor 150. There may be a plurality of sensors 150. The sensor 150 may be connected to the processor 110. The sensor 150 may be configured to detect triggering information.

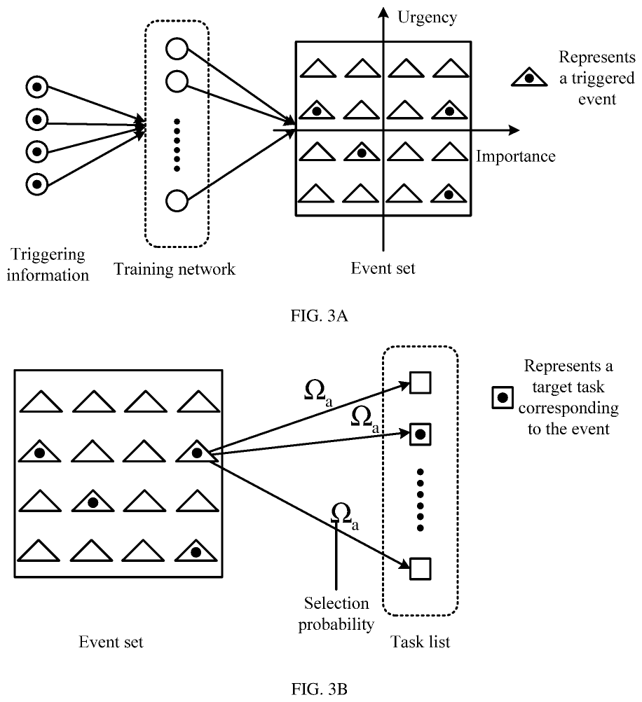

The following describes, in detail with reference to specific implementations, a processing procedure shown in FIG. 2. Content may be as follows.

Step 201. When at least one piece of triggering information is detected, determine, based on the at least one piece of triggering information, at least one to-be-processed event triggered by the at least one piece of triggering information, where the determined at least one event is different from each other.

The triggering information may be information that is detected by a robot and that is used to trigger the robot to determine an event, or may be outside information detected using a sensor. The event may be an event that can be recognized by the robot. In an embodiment, the event is an event that happens outside and that can be determined by the robot when the robot detects the triggering information.

During implementation, various types of components (for example, a photographing component and a voice obtaining component) may be disposed on the robot, and the robot may detect the triggering information using the various types of components. Each time when the robot detects the at least one piece of triggering information, the robot may combine all detected triggering information to determine the at least one to-be-processed event that is different from each other and that is triggered by all the triggering information. The triggering information detected by the robot is not in one-to-one correspondence with the event, and different triggering information may trigger a same event. The detected at least one piece of triggering information may be detected at the same time, or may be detected within relatively short preset duration. For example, when a person falls on the ground, the person may utter voice information. In this case, the voice obtaining component of the robot may detect the voice information, perform speech recognition on the voice information, and detect triggering information “A person falls on the ground”. In addition, the photographing component of the robot may further take an image that a person falls on the ground, and therefore generate triggering information “A person falls on the ground”. After detecting the two pieces of triggering information, the robot may combine the two pieces of triggering information to determine that a to-be-processed event triggered by the two pieces of triggering information is “A person falls on the ground”.

Optionally, the determined at least one event may be a remaining event after a repeated event is deleted. Correspondingly, a processing procedure of step 201 may be as follows, when the robot detects the at least one piece of triggering information, determining an event triggered by each piece of detected triggering information, and performing deduplication processing on all determined events, to obtain the at least one to-be-processed event triggered by the at least one piece of triggering information.

In an embodiment, the robot may pre-store a correspondence between triggering information and an event, and when detecting the at least one piece of triggering information, may determine, based on the correspondence, the event corresponding to each piece of triggering information. When the determined events include same events, the robot may delete a repeated event such that the eventually determined events are different from each other. In addition, when the determined events include an event in a to-be-processed event list, the event may be deleted. In an embodiment, when detecting the at least one piece of triggering information, the robot may determine, based on the at least one piece of triggering information and the event in the to-be-processed event list, the at least one to-be-processed event triggered by the at least one piece of the triggering information. The determined at least one event is different from each other.

Optionally, the robot may determine, using a classification model, the event triggered by each piece of triggering information. Correspondingly, a processing procedure may be as follows, when the intelligent device detects the at least one piece of triggering information, classifying each piece of detected triggering information based on a pre-trained classification model and each event in an event set, and determining the event corresponding to each piece of triggering information.

During implementation, when the at least one piece of triggering information is detected, the at least one event that is different from each other and that is triggered by the at least one piece of triggering information may be obtained using the pre-trained classification model (for example, a neural network algorithm). The neural network algorithm may include a visible input neuron, one or more layers of hidden neurons, and a visible output neuron. Each visible input neuron may be a plurality of pieces of detected triggering information. The visible output neuron may be a triggered event. Connection between neurons is wireless mesh interconnection, and may be further implemented using a hidden Markov model (HMM) network or overlapping restricted Boltzmann machines (RBM).

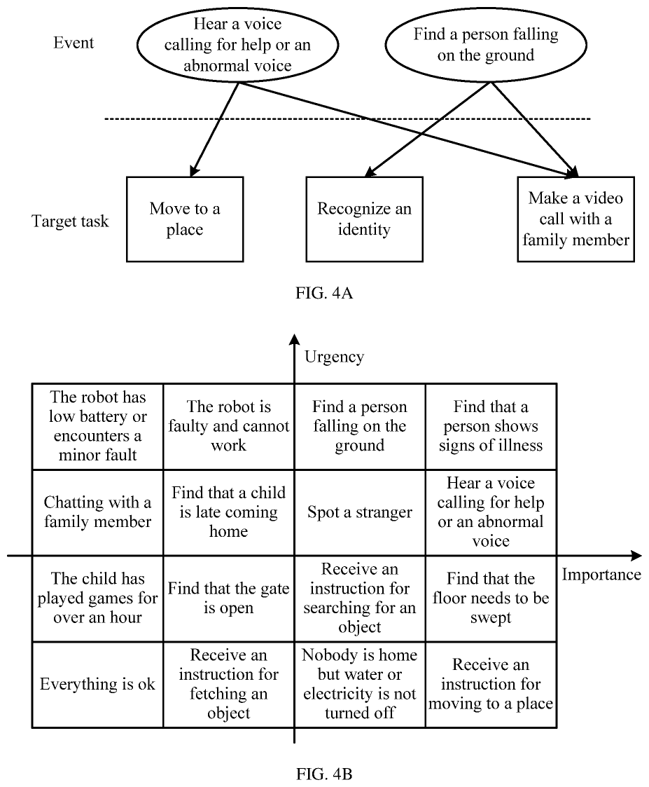

In this embodiment of this application, the neural network algorithm may serve as a classifier. In other words, each time when the robot detects the at least one piece of triggering information, the robot may use each of the at least one piece of triggering information as an input of the neural network algorithm (the classifier), classify each piece of triggering information using the neural network algorithm (that is, using a training network), and determine a category corresponding to the triggering information (that is, determine the event triggered by the triggering information). Each category in the neural network algorithm may be each event in a set of events that can be recognized by the robot, as shown in FIG. 3A. After the category of each piece of triggering information is determined, a repeated event may be deleted, to obtain the event triggered by the at least one piece of triggering information. In addition, an amount of triggering information that can be recognized by the robot is far greater than a quantity of recognizable events. For example, each time when the robot detects triggering information “Light off”, “Turn the light off”, or “Turn off the light”, the robot may determine that the triggered event is “Turn off the light”.

In addition, the robot may include a plurality of working agents and a central processing unit. The central processing unit may communicate with the working agents. Each agent may be a unit that can execute a task relatively independently, and usually has an independent sensor, an independent computing unit, and related software. For example, the robot may include a visual working agent, a voice working agent, a communications working agent, and the like. In this application, the triggering information detected by the robot may be a message sent by each working agent. The message may include a message generation time point, a working agent identifier, a message generation position, and a message body (the message body may be a phrase formed by characters). After generating the message, each agent may send the message to the central processing unit such that the central processing unit performs processing of step 201.

Step 202. Select, for each determined event and from at least one task corresponding to the event, a target task corresponding to the event.

The target task may be a task selected when the event is processed this time.

During implementation, the robot may store at least one task corresponding to each event in the event set, and each event in the event set is an event that can be recognized by the robot. In other words, each event may correspond to one or more processing manners (tasks), and different events may correspond to a same task. After the at least one triggered event is determined, the at least one triggered event may be added to the to-be-processed event list. In addition, for each of the at least one event, the robot may determine, from the pre-stored at least one task corresponding to each event in the event set, the at least one task corresponding to the event, and then may determine, from the at least one corresponding task, the target task corresponding to the event. The at least one task may be a processing manner that can be used for processing the event. For example, for an event “A person falls on the ground”, a corresponding task may be dialing a preset phone number, making a video call, or the like. Further, the robot may randomly determine, from the at least one corresponding task and based on a preset randomization algorithm, the target task corresponding to the event, that is, determine a processing manner used for processing the event this time, as shown in FIG. 3B. A processing procedure of the step may be further implemented using a Markov decision network. The triggered event may be used as an input of the Markov decision network, and the target task corresponding to each event is an output of the Markov decision network. The Markov decision network generally includes two categories of neurons, namely, a status neuron (reflecting arrangement and an activation status of the event set) and an action neuron (the action neuron may be in full connection, or may be in mesh connection).

Optionally, each task corresponding to each event may correspond to a selection probability. Further, the robot selects, based on a selection probability, the task corresponding to the event. Correspondingly, a processing procedure of step 202 may be as follows, for each of the determined at least one event, selecting, from the at least one task corresponding to the event and based on the selection probability of each of the at least one task corresponding to the event, the target task corresponding to the event.

During implementation, in addition to the at least one task corresponding to each event in the event set, the robot may further store the selection probability corresponding to each task, that is, may store a correspondence between an event, a task, and a selection probability. Different events may correspond to a same task. When a same task corresponds to different events, corresponding selection probabilities may be the same or may be different, as shown in Table 1. In addition, a sum of selection probabilities of all events corresponding to each task may further be 1.

TABLE 1

| Event | Task | Selection probability |
|---|---|---|
| Event 1 | Task a | 0.9 |
| | Task b | 0.1 |
| Event 2 | Task c | 0.8 |
| | Task a | 0.1 |
| Event 3 | Task d | 0.6 |
| | Task b | 0.9 |

After determining the at least one triggered event, for each of the at least one event, the robot may determine, based on the correspondence, the at least one task corresponding to the event, and then may randomly select, from a plurality of tasks and based on the selection probability corresponding to each determined task, the target task corresponding to the event. The selection probability represents a possibility that a corresponding task is selected. For example, the at least one task corresponding to the event 1 is a task a and a task b, a selection probability corresponding to the task a is 0.9, and a selection probability corresponding to the task b is 0.1. Then, the robot may determine a target task in a manner of generating a random number from 1 to 10. In an embodiment, when the generated random number is one of 1 to 9, the task a may be determined as the target task, and when the generated random number is 10, the task b may be determined as the target task.

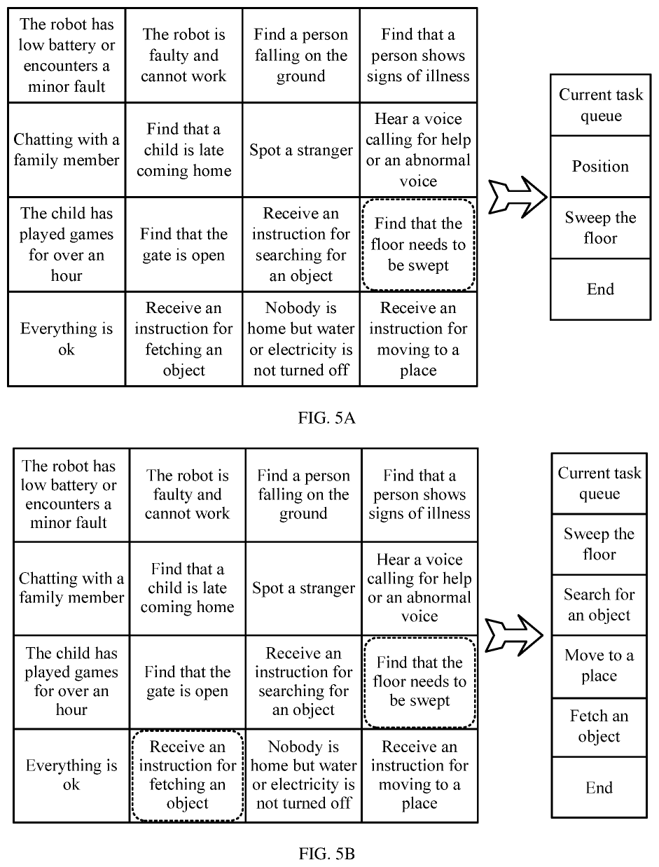

In addition, when the event is triggered, if the determined target task definitely includes a task, a selection probability of the task corresponding to the event is 1. In an embodiment, in this case, if the event is triggered, the target task that is determined by the robot and that corresponds to the event certainly includes the task. For example, a target task corresponding to an event “Hear a voice calling for help or an abnormal voice” may include “Move to a place” and “Make a video call with a family member”, and the target task corresponding to the event “Find a person falling on the ground” may include “Recognize an identity” and “Make a video call with a family member”, as shown in FIG. 4A.

Optionally, when using the robot, the user may adjust, through manual intervention, a selection probability of each task corresponding to an event. Correspondingly, a processing procedure may be as follows, when a satisfaction degree value entered for execution of a first task of a target task corresponding to a first event is received, adjusting, based on the entered satisfaction degree value, a selection probability of the first task corresponding to the first event.

The first event may be any one of events that have been processed by the robot.

During implementation, a human-computer interaction interface (a visible graphical interface and a touch manner) may be disposed on the robot, and a user may make manual intervention using the human-computer interaction interface. Further, each time after the robot executes the target task corresponding to the triggered event (which may be referred to as the first event), that is, after the robot executes a target task corresponding to an event or when the robot executes a target task corresponding to an event, the user may enter, based on a satisfaction degree of the user, a satisfaction degree value for current execution of the first task of the target task corresponding to the event, and the robot may receive the satisfaction degree value (which may be represented by s, and s may be a value greater than 0 and less than 1) that is entered by the user for execution of the first task corresponding to the first event by the robot. In this case, the robot may adjust the selection probability of the first task corresponding to the first event. In addition, the robot may further adjust a selection probability of an event other than the first event of all events corresponding to the first task. Further, after obtaining the satisfaction degree value s entered by the user, the robot may calculate, according to the formula (1), an excitation value ΔΩₐ of a selection probability of the first event (which may be represented by a) corresponding to the first task, calculate, according to the formula (2), a new selection probability of the first event a corresponding to the first task, and calculate, according to the formula (3), a new selection probability Ωᵢ of another event corresponding to the first task.

ΔΩₐ=Ωₐ*(s−0.5)/0.5 (1)

Ωₐ=Ωₐ+ΔΩₐ (2)

Ωᵢ=Ωᵢ−ΔΩₐ/(z−1) i≠a (3)

where i may be any integer between 1 and z, z is a quantity of all events corresponding to the first task, Ωₐ represents a selection probability of the event a corresponding to the first task before adjustment, and Ωᵢ represents a selection probability of an event i corresponding to the first task before adjustment.

Step 203. Execute the target task corresponding to each event.

During implementation, after determining the target task corresponding to each event, the robot may execute the target task corresponding to each event. The robot may include a plurality of functional modules, and each functional module may execute a task. In an embodiment, the robot may separately execute, using the plurality of functional modules, each task in the target task corresponding to each event. In addition, after determining the target task corresponding to each event, the robot may add the target task of each event to a current task queue, and each time after a target task is executed, the robot may delete the target task from the current task queue, and delete an event corresponding to the target task from the to-be-processed event list. If the current task queue includes a target task that is determined previously and that corresponds to the event, adding a target task that is determined this time and that corresponds to the triggered event to the current task queue is equivalent to updating the current task queue. A list of all tasks that can be executed by the robot may include system self-test, positioning, map construction, moving to a place, recognizing a family member, recognizing an identity, recognizing an object, recognizing a gesture, audio (voice or sound) understanding and synthesis, autonomous charging, searching for an object, fetching an object, sweeping the floor, making a video call with a person, and sending a short message service message to a person.

In addition, when the user uses the robot, a new functional module may be added to the robot (for example, corresponding hardware and a corresponding functional program may be added), and for a task that can be implemented by the newly added functional module, a corresponding selection probability may be set for a corresponding event. When using the robot, the user may further make manual intervention such that the robot adjusts, based on the foregoing method, a selection probability that is of the task that can be implemented by the newly added functional module and that corresponds to the corresponding event.

Optionally, after determining the at least one triggered event, the robot may determine a priority of processing each event. Correspondingly, a processing procedure may be as follows determining, based on pre-stored importance and urgency that correspond to each event in the event set, importance and urgency that correspond to each of the at least one event, and determining, for each event, the priority of the event based on the determined importance and urgency that correspond to the event. Correspondingly, a processing procedure of step 203 may be as follows executing, based on the priority of each event in descending order of priorities, the target task corresponding to each event.

During implementation, the robot may pre-store the importance and urgency that correspond to each event in the event set. After determining the at least one triggered event, the robot may determine, from the pre-stored importance and urgency that correspond to events in the event set, the importance and urgency that correspond to each of the at least one event, and then may determine, for each event, the priority of the event based on the determined importance and urgency that correspond to the event. For example, a sum of the importance and urgency that correspond to the event may be calculated, and the calculated sum may be used as the priority of the event. After determining the priority of each event, the robot may execute, in descending order of priorities, the target task corresponding to each event.

Optionally, during priority calculation, an expected cost of current execution of the target task corresponding to the event may be considered. Correspondingly, a processing procedure may be as follows, for each event, obtaining an actual cost and an expected cost of previous execution of a task corresponding to the event, determining, based on the actual cost and the expected cost of the previous execution of the task corresponding to the event, an expected cost required for current execution of the target task corresponding to the event, and determining the priority of the event based on the determined importance and urgency that correspond to the event and the determined expected cost required for the current execution of the target task corresponding to the event.

During implementation, each time after the robot executes a task corresponding to each event in the event set, that is, each time after the robot processes the event, the robot may record an actual cost of current execution of the task corresponding to the event, and calculate an expected cost required for next execution of a task corresponding to the event. The actual cost may be energy (for example, electric power or central processing unit usage) or time consumed for executing the task corresponding to the event, or may be a combination of energy and time.

An event a is used as an example to describe a processing procedure of determining a priority of the event a. The event a is any event in the event set. Further, the robot may preset an expected cost T_{a,1}=1 of first processing of the event a, and the robot may calculate, according to the formula (4), an expected cost of each execution of a task corresponding to the event a, where i represents that the event a is processed for an i^{th} time

T_{a,i+1}=pT_{a,i}+(1−p)Δw_{a,i}Δt_{a,i} (4)

where T_{a,i+1} represents an expected cost required for (i+1)^{th}-time processing of the event a, i is a positive integer greater than or equal to 1, T_{a,i} represents an expected cost required for i^{th}-time processing of the event a, p is a weighted value, and may be a value between 0 and 1 (for example, may be a value less than 0.5), Δw_{a,i} and Δt_{a,i} respectively represent energy and time actually consumed for the i^{th}-time processing of the event a, and Δw_{a,i}Δt_{a,i} represents an actual cost of the i^{th}-time processing of the event a.

After an expected cost required for i^{th}-time execution of the task corresponding to the event a is determined according to the formula (4), and importance (which may be represented by (Φₐ) and urgency (which may be represented by Ψₐ) that correspond to the event a are obtained, when the event is triggered for the i^{th} time, a priority Θₐ of current execution of the task corresponding to the event a may be calculated according to the formula (5).

Θₐ=Φₐ+Ψₐ/T_{a,i} (5)

After determining at least one currently-triggered event, for each event, the robot may obtain the actual cost and the expected cost of the previous execution of the task corresponding to the event, and then may determine, according to the formula (4), the expected cost required for the current execution of the target task corresponding to the event. After obtaining the expected cost and corresponding importance and urgency, the robot may determine the priority of the event according to the formula (5).

Optionally, the importance and urgency that correspond to each event in the event set may be obtained using an importance-urgency matrix. Correspondingly, a processing procedure of determining the importance and urgency of each event may be as follows determining, based on the pre-stored importance-urgency matrix and an event corresponding to each position in the importance-urgency matrix, the importance and urgency that correspond to each of the at least one event, where each position in the importance-urgency matrix represents importance and urgency of the event corresponding to the position.

During implementation, the robot may pre-store the importance-urgency matrix. Positions in the importance-urgency matrix correspond to different events, and each position represents the importance and urgency of the event corresponding to the position, as shown in FIG. 4B. The matrix may be referred to as an EDM. After determining the at least one event, the robot may determine, from the importance-urgency matrix, importance and urgency that correspond to a position of each of the at least one event in the importance-urgency matrix.

Optionally, the position of each event in the importance-urgency matrix is determined using corresponding probabilities of the event in positions. Correspondingly, a processing procedure may be as follows, for each event in the event set, determining, based on pre-stored corresponding probabilities of the event in the positions in the importance-urgency matrix, a position corresponding to a largest probability as the position corresponding to the event.

During implementation, the robot may preset the corresponding probabilities of each event in the positions in the importance-urgency matrix. The probability may be a value having a preset quantity of digits, and a sum of the corresponding probabilities of each event in the positions in the importance-urgency matrix is 1. For each event in the event set, when determining the position of each event in the importance-urgency matrix, the robot may determine the largest probability from the corresponding probabilities of the event in the positions in the importance-urgency matrix, and then may determine the position corresponding to the largest probability as the corresponding position of the event in the importance-urgency matrix.

In an embodiment, the importance-urgency matrix may be an m*n EDM, and a quantity of the events in the event set is m*n. For the event a, assuming that a probability of the event a in a position (i, j) in EDM is Pᵢⱼ(a) (i∈[0, m), j ∈[0, n)), and a sum of corresponding probabilities of the event a in the positions in the importance-urgency matrix is 1, a normalization condition is satisfied.

1=Σⱼ₌₀^{n.>j}Σᵢ₌₀^{m>i}Pᵢⱼ(a)

Assuming that an actual position of the event a in the importance-urgency matrix is (i′, j′), a corresponding probability of the event a in the position is largest, and satisfies the following formula.

P_{i′j′}(a)=max{Pᵢⱼ(a)}

Optionally, the user may adjust, using the human-machine interaction interface of the robot, the corresponding position of each event in the event set in the importance-urgency matrix. Each time when the user adjusts the corresponding position of the event in the importance-urgency matrix, the robot may correspondingly adjust the corresponding probabilities of the event in the positions in the importance-urgency matrix. Based on different probability adjustment methods, there may be a variety of specific processing manners, and several feasible processing manners are provided below.

Manner 1. When an instruction for adjusting a position corresponding to a second event from a first position to a second position is received, an excitation factor corresponding to each position in the importance-urgency matrix for the adjustment instruction is obtained, where an excitation factor corresponding to the second position is largest, and an excitation factor corresponding to the first position is smallest. New corresponding probabilities of the second event in the positions in the importance-urgency matrix are calculated based on the obtained excitation factor corresponding to each position in the importance-urgency matrix and corresponding probabilities of the second event in the positions in the importance-urgency matrix. The second position corresponding to a new largest probability is determined as the position corresponding to the event based on the new corresponding probabilities of the second event in the positions in the importance-urgency matrix.

The second event may be any event in the event set.

During implementation, the robot may pre-store the excitation factor Kᵢⱼ corresponding to each position in the importance-urgency matrix. For different adjustment instructions, excitation factors corresponding to each position in the importance-urgency matrix are different. For an event whose position is adjusted, an excitation factor corresponding to a position after adjustment is largest, an excitation factor corresponding to a position before adjustment is smallest, and an excitation factor corresponding to another position is between the largest and the smallest. When the user adjusts the position corresponding to the second event from the first position to the second position, the robot may receive the instruction for adjusting the position corresponding to the second event from the first position to the second position. In this case, the robot may obtain the excitation factor corresponding to each position in the importance-urgency matrix for the adjustment instruction, and then may adjust, using the excitation factor corresponding to each position, a corresponding probability of the second event in each position in the importance-urgency matrix, to obtain the new corresponding probabilities of the second event in the positions in the importance-urgency matrix (that is, obtain the corresponding probabilities of the second event in the positions in the importance-urgency matrix after position adjustment). After obtaining the new corresponding probabilities of the second event in the positions in the importance-urgency matrix, the robot may determine, based on the new corresponding probabilities of the second event in the positions in the importance-urgency matrix, the second position corresponding to the new largest probability as the position corresponding to the event.

In an embodiment, it is assumed that the event a is the second event, the first position is (i′, j′), the second position is (i″, j″), the corresponding probability of the second event in each position in the importance-urgency matrix before adjustment is Pᵢⱼ(a), the corresponding probability of the second event in each position in the importance-urgency matrix after adjustment is P′ᵢⱼ(a), and the excitation factor is Kᵢⱼ. The robot may calculate, according to the formula (6), the new corresponding probabilities of the second event a in the positions in the importance-urgency matrix.

P′ᵢⱼ(a)=Kᵢⱼ*Pᵢⱼ(a)/Σ_{i=0, j=0}^{m>i, j>n}(Kᵢⱼ*Pᵢⱼ(a)) (6)

It may be learned that P′ᵢⱼ(a) is normalized. In addition, a value of Kᵢⱼ may be shown as follows.
Kᵢⱼ=0.8 (when i=1′, j=j′)
Kᵢⱼ=1.2 (when i=i″, j=j″)
Kᵢⱼ=0.95 (another position)

It may be learned that a new corresponding probability of the second event in the second position in the importance-urgency matrix is largest. In an embodiment, after adjustment by the user, the second position adjusted by the user is the corresponding position of the second event in the importance-urgency matrix.

Manner 2. When an instruction for adjusting a position corresponding to a second event from a first position to a second position is received, a corresponding probability of the second event in the first position in the importance-urgency matrix is determined as a new corresponding probability of the second event in the second position, and a corresponding probability of the second event in the second position in the importance-urgency matrix is determined as a new corresponding probability of the second event in the first position. The second position corresponding to a new largest probability is determined as the position corresponding to the event based on new corresponding probabilities of the second event in the positions in the importance-urgency matrix.

During implementation, when receiving the instruction for adjusting the position corresponding to the second event from the first position to the second position, the robot may adjust only the corresponding probabilities of the second event in the first position and the second position, and does not adjust probabilities corresponding to the other positions. Further, when the instruction for adjusting the position corresponding to the second event from the first position to the second position is received, the corresponding probability of the second event in the first position in the importance-urgency matrix may be determined as the new corresponding probability of the second event in the second position, and the corresponding probability of the second event in the second position in the importance-urgency matrix may be determined as the new corresponding probability of the second event in the first position. In other words, the robot may interchange the probability of the second event in the first position and the probability of the second event in the second position before adjustment, and determine the interchanged probabilities as the new corresponding probability of the second event in the first position after adjustment and the new corresponding probability of the second event in the second position after adjustment. New probabilities of the second event in the other positions after adjustment are the same as the probabilities of the second event in the other positions before adjustment. After the new corresponding probabilities of the second event in the positions in the importance-urgency matrix are obtained, the second position corresponding to the new largest probability may be determined as the position corresponding to the event.

The new corresponding probabilities of the second event in the positions in the importance-urgency matrix may be calculated according to the formula (6), and a definition of the excitation factor Kᵢⱼ corresponding to each position is different from a definition in manner 1, and may be as follows.

Kᵢⱼ=P_{i″j″}(a)/P_{i′j′}(a)

(when i=i′, j=j′)

Kᵢⱼ=P_{i′j′}(a)/P_{i″j″}(a)

(when i=i″, j=j″)

Kᵢⱼ=0.95 (another position)

It may be learned that the new corresponding probability of the second event in the second position in the importance-urgency matrix is largest. In an embodiment, after adjustment by the user, the second position adjusted by the user is the corresponding position of the second event in the importance-urgency matrix.

In addition, that the user adjusts the corresponding position of the second event in the importance-urgency matrix is equivalent to that positions of two events in the importance-urgency matrix are interchanged. In other words, when the position corresponding to the second event is adjusted from the first position to the second position, a position corresponding to a third event whose original corresponding position is the second position is adjusted from the second position to the first position. In other words, after the user adjusts the position corresponding to the second event, when re-determining, in manner 1 or manner 2, the position corresponding to the second event, the robot may further re-determine, in manner 1 or manner 2, the position corresponding to the third event. A specific implementation procedure is similar to that of the second event, and details are not described herein again.

Optionally, when the second event for which the corresponding position is adjusted is a to-be-processed event, the robot may re-calculate a priority of the second event. Correspondingly, a specific processing procedure may be as follows, when the second event is a to-be-processed event, re-determining, based on importance and urgency that correspond to the second position in the importance-urgency matrix, the priority corresponding to the second event.

During implementation, as described above, after the at least one triggered event and the target task corresponding to each event are determined, the target task corresponding to each of the at least one event may be added to a current task queue, and after the target task is executed, the target task may be deleted from the current task queue. Based on this case, when a target task corresponding to the second event is in the current task queue, the second event may be determined as a to-be-processed event. In other words, the to-be-processed event may include an event being processed. In addition, the to-be-processed event may alternatively not include an event being processed.

When the second event is a to-be-processed event, the robot may re-calculate, based on the foregoing method for determining a priority of an event, the priority corresponding to the second event. Further, the robot may execute, based on the re-calculated priority, the target task corresponding to the second event. For a case in which the to-be-processed event includes an event being processed, when the re-calculated priority is decreased, execution of the target task corresponding to the event may be suspended, and a target task corresponding to an event having a higher priority is executed.

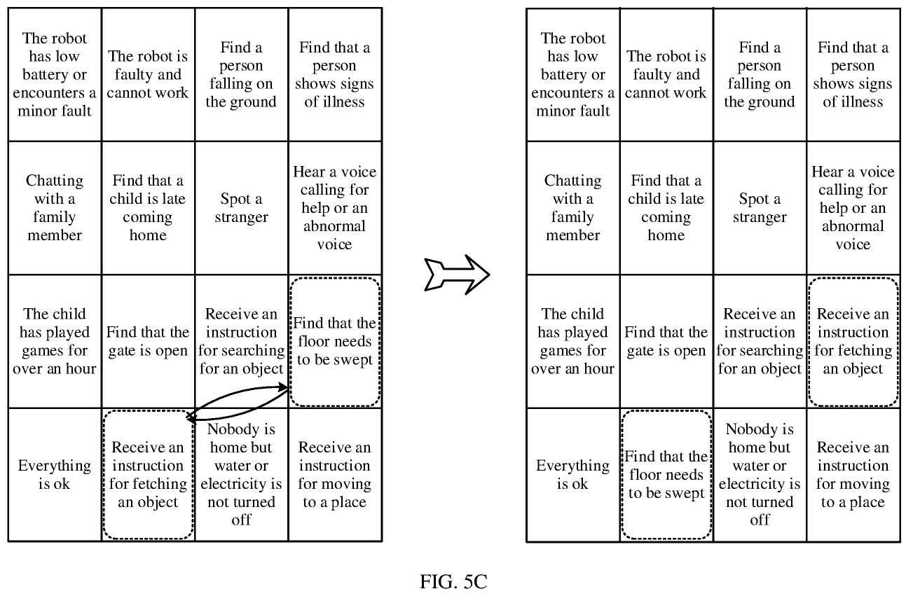

For example, the robot detects, using a component, triggering information “There is dirt on the ground”, determines that an event triggered by the triggering information is “Find that the floor needs to be swept”, and then may add a target task corresponding to the event to a current task queue, as shown in FIG. 5A. In this case, the robot further detects, using another component, triggering information “Bring me medicine”, determines that an event triggered by the triggering information is “An object needs to be fetched”, and then may add a target task corresponding to the event to the current task queue, as shown in FIG. 5B. It is calculated, based on importance and urgency that correspond to the two events, that a priority of the event “Find that the floor needs to be swept” is higher than that of the event “An object needs to be fetched”. When the user is not satisfied with the priorities, corresponding positions of the two events in the importance-urgency matrix may be adjusted. In other words, the importance and urgency of the two events may be adjusted, as shown in FIG. 5C. Correspondingly, the robot may re-calculate the priorities of the two events (to learn that the priority of the event “An object needs to be fetched” is higher than that of the event “Find that the floor needs to be swept”), and change a sequence of the target tasks corresponding to the two events in the current task queue, as shown in FIG. 5D. Eventually, the robot may first execute the target task corresponding to the event “An object needs to be fetched”, and after completing the execution, may delete the target task corresponding to the event “An object needs to be fetched” from the current task queue, as shown in FIG. 5E, and continue to execute the target task corresponding to the event “Find that the floor needs to be swept”.

In this embodiment of this application, when the at least one piece of triggering information is detected, the at least one to-be-processed event corresponding to the at least one piece of triggering information is determined based on the at least one piece of triggering information, where the determined at least one event is different from each other. For each of the determined at least one event, the target task corresponding to the event is selected from the at least one task corresponding to the event. The target task corresponding to each event is executed. In this way, the robot combines the detected triggering information to determine events that are different from each other in order to prevent a corresponding task from being executed twice for a same event corresponding to different triggering information, thereby preventing resource waste.

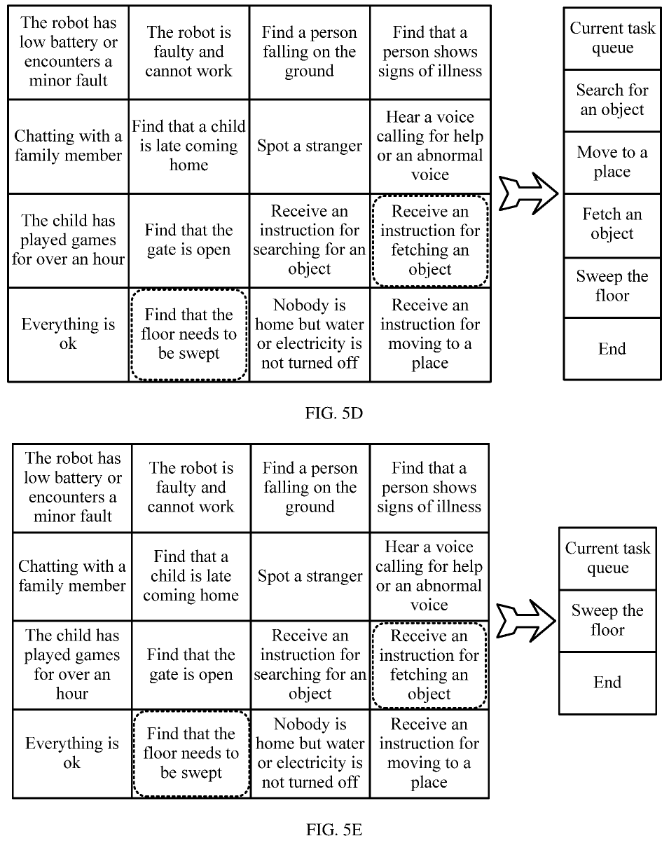

Based on a same technical idea, an embodiment of this application further provides an apparatus for executing a task by an intelligent device. As shown in FIG. 6, the apparatus includes a determining module 610 and an execution module 620.

The determining module 610 is configured to, when at least one piece of triggering information is detected, determine, based on the at least one piece of triggering information, at least one to-be-processed event triggered by the at least one piece of triggering information, where the determined at least one event is different from each other, the triggering information is outside information detected by an intelligent device using a sensor, and the event is an event that happens outside and that is determinable for the intelligent device when the intelligent device detects the triggering information. A determining function in step 201 and other implicit steps may be further implemented.

The determining module 610 is further configured to select, for each determined event and from at least one task corresponding to the event, a target task corresponding to the event, where the task is a processing manner available to the intelligent device for the event that happens outside. A determining function in step 202 and other implicit steps may be further implemented.

The execution module 620 is configured to execute the target task corresponding to each event. An execution function in step 203 and other implicit steps may be further implemented.

Optionally, the determining module 610 is configured to, when the intelligent device detects the at least one piece of triggering information, determine an event triggered by each piece of detected triggering information, and perform deduplication processing on all determined events, to obtain the at least one to-be-processed event triggered by the at least one piece of triggering information.

Optionally, the determining module 610 is configured to, when the intelligent device detects the at least one piece of triggering information, classify each piece of detected triggering information based on a pre-trained classification model and each event in an event set, and determine the event corresponding to each piece of triggering information.

Optionally, the determining module 610 is configured to, for each determined event, select, from the at least one task corresponding to the event and based on a selection probability of each of the at least one task corresponding to the event, the target task corresponding to the event.

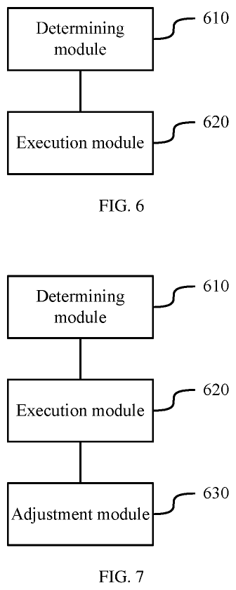

Optionally, as shown in FIG. 7, the apparatus further includes an adjustment module 630 configured to, when a satisfaction degree value entered for execution of a first task of a target task corresponding to a first event is received, adjust, based on the entered satisfaction degree value, a selection probability of the first task corresponding to the first event.

Optionally, the determining module 610 is further configured to determine, based on pre-stored importance and urgency that correspond to each event in an event set, importance and urgency that correspond to each of the at least one event, and determine, for each event, a priority of the event based on the determined importance and urgency that correspond to the event, and the execution module 620 is configured to execute, based on the priority of each event in descending order of priorities, the target task corresponding to each event.

Optionally, the determining module 610 is configured to, for each event, obtain an actual cost and an expected cost of previous execution of a task corresponding to the event, determine, based on the actual cost and the expected cost of the previous execution of the task corresponding to the event, an expected cost required for current execution of the target task corresponding to the event, and determine the priority of the event based on the determined importance and urgency that correspond to the event and the determined expected cost required for the current execution of the target task corresponding to the event.

Optionally, the determining module 610 is configured to determine, based on a pre-stored importance-urgency matrix and an event corresponding to each position in the importance-urgency matrix, the importance and urgency that correspond to each of the at least one event, where each position in the importance-urgency matrix represents importance and urgency of the event corresponding to the position.

Optionally, the determining module 610 is further configured to, for each event in the event set, determine, based on pre-stored corresponding probabilities of the event in positions in the importance-urgency matrix, a position corresponding to a largest probability as a position corresponding to the event.

Optionally, the determining module 610 is further configured to, when an instruction for adjusting a position corresponding to a second event from a first position to a second position is received, obtain an excitation factor corresponding to each position in an importance-urgency matrix for the adjustment instruction, where an excitation factor corresponding to the second position is largest, and an excitation factor corresponding to the first position is smallest, calculate, based on the obtained excitation factor corresponding to each position in the importance-urgency matrix and corresponding probabilities of the second event in the positions in the importance-urgency matrix, new corresponding probabilities of the second event in the positions in the importance-urgency matrix, and determine, based on the new corresponding probabilities of the second event in the positions in the importance-urgency matrix, the second position corresponding to a new largest probability as the position corresponding to the event.

Optionally, the determining module 610 is further configured to, when an instruction for adjusting a position corresponding to a second event from a first position to a second position is received, determine a corresponding probability of the second event in the first position in an importance-urgency matrix as a new corresponding probability of the second event in the second position, and determine a corresponding probability of the second event in the second position in the importance-urgency matrix as a new corresponding probability of the second event in the first position, and determine, based on new corresponding probabilities of the second event in positions in the importance-urgency matrix, the second position corresponding to a new largest probability as the position corresponding to the event.

Optionally, the determining module 610 is further configured to, when the second event is a to-be-processed event, re-determine, based on importance and urgency that correspond to the second position in the importance-urgency matrix, a priority corresponding to the second event.

It should be noted that the determining module 610, the execution module 620, and the adjustment module 630 may be implemented by a processor, or may be implemented by a processor along with a memory, or may be implemented by a processor executing a program instruction in a memory.

In this embodiment of this application, when the at least one piece of triggering information is detected, the at least one to-be-processed event corresponding to the at least one piece of triggering information is determined based on the at least one piece of triggering information, where the determined at least one event is different from each other. For each of the determined at least one event, the target task corresponding to the event is selected from the at least one task corresponding to the event. The target task corresponding to each event is executed. In this way, a robot combines detected triggering information to determine events that are different from each other in order to prevent a corresponding task from being executed twice for a same event corresponding to different triggering information, thereby preventing resource waste.

It should be noted that when the apparatus for executing a task provided in the foregoing embodiment executes a task, only division of the foregoing functional modules is used as an example for description. In an actual application, the foregoing functions may be allocated to different functional modules for implementation according to needs. In other words, an inner structure of the intelligent device may be divided into different functional modules, to implement all or some functions described above. In addition, the apparatus for executing a task provided in the foregoing embodiment and the embodiment of the method for executing a task belong to a same idea. For a specific implementation process, refer to the method embodiment, and details are not described herein again.

The foregoing embodiments may be implemented completely or partially by software, hardware, firmware, or any combination thereof. When the foregoing embodiments are implemented by software, the foregoing embodiments may be completely or partially implemented in a form of a computer program product. The computer program product includes one or more computer instructions. When an intelligent device loads and executes the computer instruction, procedures or functions described in the embodiments of this application are completely or partially generated. The computer instruction may be stored in a computer-readable storage medium or may be transmitted from a computer-readable storage medium to another computer-readable storage medium. For example, the computer instruction may be transmitted from a website, computer, server, or data center to another website, computer, server, or data center in a wired (for example, a coaxial optical cable, an optical fiber, or a digital subscriber line (DSL)) or wireless (for example, infrared, radio, or microwave) manner. The computer-readable storage medium may be any available medium accessible by the intelligent device, or a data storage device, such as a server or a data center, integrating one or more available mediums. The available medium may be a magnetic medium (for example, a floppy disk, a hard disk, or a magnetic tape), an optical medium (for example, a digital versatile disc (DVD)), or a semiconductor medium (for example, a solid-state drive).

The foregoing descriptions are merely the embodiments of this application, but are not intended to limit this application. Any modification, equivalent replacement, and improvement made without departing from the spirit and principle of this application shall fall within the protection scope of this application.

What is claimed is:

1. A task execution method implemented by an intelligent device, comprising:
detecting a piece of triggering information using a sensor;
determining, based on the piece of triggering information, at least one to-be-processed event triggered by the piece of triggering information, wherein the at least one to-be-processed event occurs external to the intelligent device;
selecting, for each of the at least one to-be-processed event and from at least one task corresponding to the at least one to-be-processed event, a target task corresponding to the at least one to-be-processed event, wherein the at least one task is a process available to the intelligent device in response to the at least one to-be-processed event; and
executing the target task corresponding to each of the at least one to-be-processed event.

2. The task execution method of claim 1, wherein determining, based on the piece of triggering information, the at least one to-be-processed event triggered by the piece of triggering information comprises performing deduplication processing on all of the at least one to-be-processed event to obtain the at least one to-be-processed event triggered by the piece of triggering information.

3. The task execution method of claim 1, wherein determining, based on the piece of triggering information, the at least one to-be-processed event triggered by the piece of triggering information comprises classifying the piece of triggering information based on a pre-trained classification model and the at least one to-be-processed event in an event set.

4. The task execution method of claim 1, wherein the target task is selected from the at least one task corresponding to the at least one to-be-processed event based on a selection probability of each of the at least one task corresponding to the at least one to-be-processed event.

5. The task execution method of claim 4, further comprising adjusting, based on a satisfaction degree value, the selection probability of a first task corresponding to a first event in response to receiving the satisfaction degree value entered for the first task.

6. The task execution method of claim 1, further comprising:
determining, based on a pre-stored importance and a pre-stored urgency that correspond to each of the at least one to-be-processed event in an event set, an importance and an urgency that correspond to each of the at least one to-be-processed event; and
determining a priority corresponding to each of the at least one to-be-processed event based on the importance and the urgency that correspond to the at least one to-be-processed event, wherein the target task corresponding to each of the at least one to-be-processed event is executed based on the priority of each of the at least one to-be-processed event in descending order of priorities, wherein the target task corresponds to each of the at least one to-be-processed event.

7. The task execution method of claim 6, wherein determining the priority corresponding to each of the at least one to-be-processed event based on the importance and the urgency that correspond to the at least one to-be-processed event comprises:
obtaining, for each of the at least one to-be-processed event, an actual cost and an expected cost of previous execution of the at least one task corresponding to the at least one to-be-processed event;
determining, based on the actual cost and the expected cost of the previous execution of the at least one task corresponding to the at least one to-be-processed event, an expected cost required for current execution of the target task corresponding to the at least one to-be-processed event; and
determining the priority of the at least one to-be-processed event based on the importance and the urgency that correspond to the at least one to-be-processed event and the expected cost required for the current execution of the target task corresponding to the event.

8. The task execution method of claim 6, wherein the importance and the urgency that correspond to each of the at least one to-be-processed event are determined based on a pre-stored importance-urgency matrix and the at least one to-be-processed event corresponding to a position in the importance-urgency matrix, and wherein the position in the importance-urgency matrix represents an importance and an urgency of an event.

9. The task execution method of claim 8, further comprising determining, for each of the at least one to-be-processed event in the event set based on pre-stored corresponding probabilities of the event in the position in the importance-urgency matrix, the position corresponding to a largest probability as the position corresponding to the event.

10. The task execution method of claim 9, further comprising:
obtaining an excitation factor corresponding to the position in the importance-urgency matrix in response to receiving an instruction to adjust the position from a first position to a second position, corresponding to a second event, wherein the excitation factor corresponding to the second position is largest, and the excitation factor corresponding to the first position is smallest;
calculating, based on the excitation factor corresponding to the position in the importance-urgency matrix and corresponding probabilities of the second event in the positions in the importance-urgency matrix, new corresponding probabilities of the second event in the positions in the importance-urgency matrix; and
determining, based on the new corresponding probabilities of the second event in the positions in the importance-urgency matrix, the second position corresponding to a new largest probability.

11. The task execution method of claim 9, further comprising:
determining a corresponding probability of a second event in a first position in the importance-urgency matrix as a new corresponding probability of the second event in a second position, and determining a corresponding probability of the second event in the second position in the importance-urgency matrix as a new corresponding probability of the second event in the first position in response to receiving an instruction for adjusting a position corresponding to a second event from a first position to a second position; and
determining, based on the new corresponding probabilities of the second event in the positions in the importance-urgency matrix, the second position corresponding to a new largest probability as the position corresponding to the event.

12. The task execution method of claim 10, further comprising re-determining, based on the importance and the urgency that correspond to the second position in the importance-urgency matrix, a priority corresponding to the second event when the second event is another at least one to-be-processed event.

13. An intelligent device,
a sensor configured to detect a piece of triggering information;
a processor coupled to the sensor; and
a memory coupled to the processor and storing instructions that, when executed by the processor, cause the intelligent device to be configured to:
determine, based on the piece of triggering information, at least one to-be-processed event triggered by the piece of triggering information;
select, for each of the at least one to-be-processed event, from at least one task that corresponds to the at least one to-be-processed event and that is pre-stored in the memory, a target task corresponding to the at least one to-be-processed event; and
execute the target task corresponding to each of the at least one to-be-processed event, wherein the at least one to-be-processed event occurs external to the intelligent device, and wherein the at least one task is a process available to the intelligent device for the at least one to-be-processed event.

14. The intelligent device of claim 13, wherein the instructions further cause the processor to be configured to perform deduplication processing on all of the at least one to-be-processed event to obtain the at least one to-be-processed event triggered by the piece of triggering information.

15. The intelligent device of claim 14, wherein the instructions further cause the processor to be configured to classify the piece of triggering information based on a pre-trained classification model and the at least one to-be-processed event in an event set.

16. The intelligent device of claim 13, wherein the instructions further cause the processor to be configured to select, for each of the at least one to-be-processed event, from the at least one task that corresponds to the at least one to-be-processed event and that is pre-stored in the memory based on a selection probability of each of the at least one task corresponding to the at least one to-be-processed event, the target task corresponding to the event.

17. The intelligent device of claim 16, wherein the instructions further cause the processor to be configured to adjust, based on a satisfaction degree value, the selection probability of a first task corresponding to a first event in response to receiving the satisfaction degree value entered for the first task.

18. The intelligent device of claim 13, wherein the instructions further cause the processor to be configured to:
determine, based on a pre-stored importance and a pre-stored urgency that correspond to each of the at least one to-be-processed event in the event set, an importance and an urgency that correspond to each of the at least one to-be-processed event;
determine a priority corresponding to each of the at least one to-be-processed event based on the importance and the urgency that correspond to the at least one to-be-processed event; and
execute, based on the priority of each of the at least one to-be-processed event in descending order of priorities, the target task corresponding to each of the at least one to-be-processed event.

19. The intelligent device of claim 18, wherein the instructions further cause the processor to be configured to:
obtain, for each of the at least one to-be-processed event, an actual cost and an expected cost of previous execution of the at least one task corresponding to the at least one to-be-processed event;
determine, based on the actual cost and the expected cost of the previous execution of the task corresponding to the at least one to-be-processed event, an expected cost required for current execution of the target task corresponding to the at least one to-be-processed event; and
determine the priority of the at least one to-be-processed event based on the importance and the urgency that correspond to the at least one to-be-processed event and the expected cost required for the current execution of the target task corresponding to the event.

20. The intelligent device of claim 18, wherein the instructions further cause the processor to be configured to determine, based on an importance-urgency matrix pre-stored in the memory and an event corresponding to a position in the importance-urgency matrix, and wherein the position in the importance-urgency matrix represents the importance and the urgency of the event.

21. The intelligent device of claim 20, wherein the instructions further cause the processor to be configured to determine, for each of the at least one to-be-processed event in the event set, based on corresponding probabilities that are pre-stored in the memory and that are of the event in the position in the importance-urgency matrix, the position corresponding to a largest probability.

22. The intelligent device of claim 21, wherein the instructions further cause the processor to be configured to:
obtain an excitation factor corresponding to the position in the importance-urgency matrix in response to receiving an instruction to adjust the position from a first position to a second position, corresponding to a second event, wherein the excitation factor corresponding to the second position is largest and the excitation factor corresponding to the first position is smallest;
calculate, based on the excitation factor corresponding to the position in the importance-urgency matrix and corresponding probabilities of the second event in the positions in the importance-urgency matrix, new corresponding probabilities of the second event in the positions in the importance-urgency matrix; and
determine, based on the new corresponding probabilities of the second event in the positions in the importance-urgency matrix, the second position corresponding to a new largest probability.

23. The intelligent device of claim 21, wherein the instructions further cause the processor to be configured to:
determine a corresponding probability of a second event in a first position in the importance-urgency matrix as a new corresponding probability of the second event in a second position, and determine a corresponding probability of the second event in the second position in the importance-urgency matrix as a new corresponding probability of the second event in the first position in response to receiving an instruction for adjusting a position corresponding to a second event from a first position to a second position; and
determine, based on the new corresponding probabilities of the second event in the positions in the importance-urgency matrix, the second position corresponding to a new largest probability as the position corresponding to the event.

24. The intelligent device of claim 22, wherein the instructions further cause the processor to be configured to re-determine, based on importance and urgency that correspond to the second position in the importance-urgency matrix, a priority corresponding to the second event when the second event is another at least one to-be-processed event.

25. A computer program product comprising computer-executable instructions stored on a non-transitory computer-readable medium that, when executed by a processor, cause an intelligent device to:
detect a piece of triggering information;
determine, based on the piece of triggering information, at least one to-be-processed event triggered by the piece of triggering information;
select, for each of the at least one to-be-processed event, from at least one task that corresponds to the at least one to-be-processed event and that is pre-stored in the non-transitory computer-readable medium, a target task corresponding to the at least one to-be-processed event; and
execute the target task corresponding to each of the at least one to-be-processed event, wherein the at least one to-be-processed event occurs external to the intelligent device, and wherein the at least one task is a process available to the intelligent device in response to the at least one to-be-processed event.
